(19) United States
(12) Patent Application Publication
(10) Pub. No.: US 2013/0125672 A1
(43) Pub. Date: May 23, 2013

(54) MIXER-SETTLER, AN ARRANGEMENT COMPRISING AT LEAST TWO MIXER-SETTLERS AND A METHOD FOR MEASURING AND CONTROLLING THE VOLUMETRIC O/A RATIO AND PHASE DISENGAGEMENT TIME OF ORGANIC AND AQUEOUS PHASES IN A DISPERSION

(71) Applicant: Jaime Urzúa, Nunoa (CL)

(72) Inventor: Jaime Urzúa, Nunoa (CL)

(73) Assignee: OUTOTEC OYJ, Espoo (FI)

(21) Appl. No.: 13/813,207

(22) PCT Filed: Aug. 19, 2011
(86) PCT No.: PCT/FI2011/050728

§ 371 Date: Jan. 30, 2013

(30) Foreign Application Priority Data
Aug. 26, 2010 (FI) 20105892

(51) Int. Cl. G01N 1/10; B01D 11/04

(52) U.S. Cl. CPC G01N 1/10; B01D 11/0484
USPC 73/863.02; 422/119; 422/111

(57) ABSTRACT

The present invention concerns a mixer-settler, an arrangement comprising a train of at least two mixer-settlers and a method for measuring and controlling volumetric O/A ratio and phase disengagement time of organic and aqueous phases in a dispersion. A continuous flow of dispersion is led via an inlet channel (6) from the uptake channel (4) though a measurement chamber (5) to an outlet channel (9) which leads the flow to the pump-mixer unit (1). At predetermined time intervals the continuous flow of dispersion is interrupted by closing the inlet and outlet valves (12, 13) to retain a sample of dispersion in the measurement chamber (5) for the measurement of the O/A ratio and phase disengagement time.

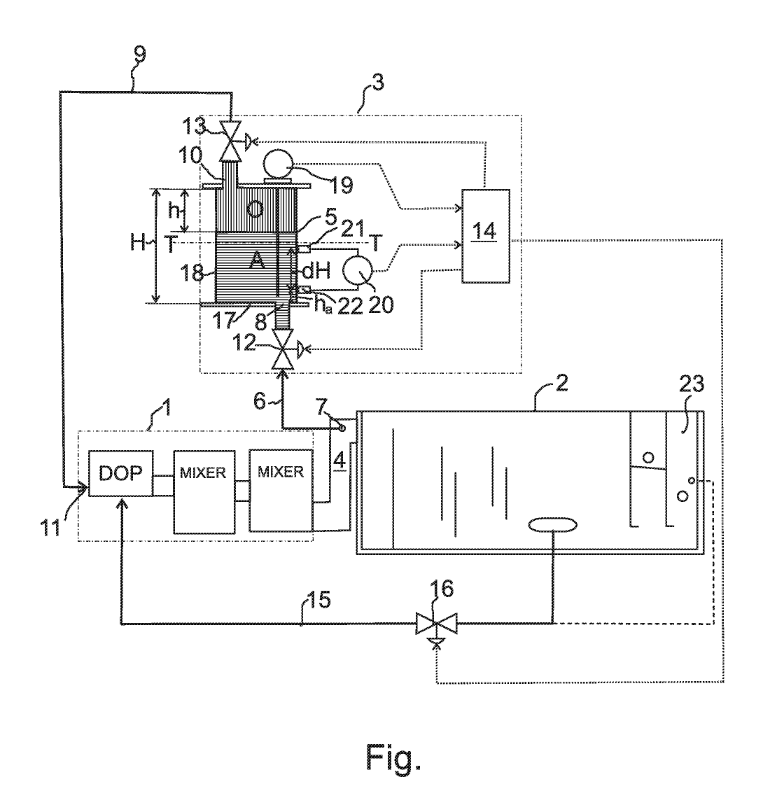

### FIELD OF INVENTION

The present invention relates to a mixer-settler in accordance with claim 1. Further, the present invention relates to an arrangement of mixer-settlers in accordance with claim 12. Also the present invention relates to a method in accordance with claim 13.

### BACKGROUND OF INVENTION

One of the usual operation tasks in a solvent extraction (SX) plant is measurement of the internal O/A ratio in each stage (typically made every 2 hours). O/A ratio is the volumetric ratio of the volume of organic phase to the volume of the aqueous phase. If this ratio is deviated from the target value, adjustments are required to achieve a targeted O/A ratio and to maintain the operational conditions.

At the moment the sampling of dispersion for the measurement and the measurement of the internal O/A ratio are manual tasks. A sample is manually taken from the uptake channel or last mixer tank and then the volumetric organic/aqueous ratio is calculated using a transparent flask. During the same operation, the phase disengagement time is measured with a chronometer. The problem is that each individual person may take the sample of dispersion from different locations of the uptake channel. This causes great deviation in the measurement results so that they may become unreliable.

The VSF® (stands for Vertical Smooth Flow) technology developed by the applicant has three key elements: a pump-mixer called Dispersion Overflow Pump (DOP®) (disclosed e.g. in document U.S. Pat. No. 5,662,871, a set of two SPIROK® helical mixers (disclosed in e.g. document U.S. Pat. No. 5,185,081), and a proprietary settler design including DDG® fences (disclosed e.g. in document U.S. Pat. No. 7,517,461). The basic idea behind the VSF® technology is to have smooth agitation throughout the SX plant to avoid oxidation of organic and development of overly small droplet size in dispersion.

In the VSF® technology, the basic O/A ratio is determined mainly on the grounds of amounts of organic and aqueous solutions fed to the pump-mixer of each stage from either a preceding stage or from reservoir tanks. The O/A ratio can vary in normal and steady state plant condition mainly by two ways: changing the DOP® rotation speed or changing the position of the internal recirculation valve in the stage. The valve in the internal recirculation channel (e.g. U.S. Pat. No. 6,083,400) regulates the recirculation of aqueous phase from the settler back to the pump-mixer.

The problem is that, if the rotation speed of the pump-mixer or the opening position of the internal recirculation valve is changed, also the level of the organic launder in the preceding stage changes and further iteration of the speed and valve position is normally needed to reach the desired target values of internal O/A ratio and launder level.

### OBJECT OF INVENTION

The object of the invention is to eliminate the above mentioned drawbacks.

A particular object of the invention is to provide a mixer-settler in which the measurement of the internal volumetric O/A ratio and phase disengagement time, and the adjustment of the internal O/A ratio on the basis of the measurements can be made in a controlled manner more reliably and makes it possible that the measurement and the adjustment can be automated.

Further, an object of the invention is to provide an arrangement of mixer settlers wherein the measurement of the internal volumetric O/A ratio and phase disengagement time, and the adjustment of the internal O/A ratio and launder level on the basis of the measurements can be automated.

Further, an object of the invention is to provide an improved method for measuring the volumetric O/A ratio and phase disengagement time of organic and aqueous phases in a dispersion which method enables the measurements and adjustments to be automated.

### SUMMARY OF INVENTION

The mixer-settler according to the invention is characterized by what is set forth in claim 1. Further, the arrangement according to the invention is characterized by what is set forth in claim 12. Moreover, the method according to the invention is characterized by what is set forth in claim 13.

The mixer-settler comprises a pump-mixer unit, a liquid-liquid extraction settler and an equipment configured to measure the volumetric O/A ratio and phase disengagement time of organic and aqueous phases in a dispersion prepared by said pump-mixer unit before feeding the dispersion to said liquid-liquid extraction settler via an uptake channel. The equipment comprises a measurement chamber arranged to receive a sample of dispersion for the measurement of the O/A ratio and the phase disengagement time.

According to the invention the equipment comprises an inlet channel having a first end opening to the uptake channel and a second end opening to the measurement chamber, said inlet channel forming a channel for the inflow of the sample into the measurement chamber; an outlet channel having a third end opening to the measurement chamber and a fourth end opening to the pump-mixer unit, said outlet channel forming a channel for the outflow of the sample out from the measurement chamber; an inlet valve which is a steered shut-off valve arranged in the inlet channel, said inlet valve having an open position to allow the flow in the inlet channel, and a closed position to stop the flow in the inlet channel; and an outlet valve which is a steered shut-off valve arranged in the outlet channel, said outlet valve having an open position to allow the flow in the outlet channel, and a closed position to stop the flow in the outlet channel. Said inlet and outlet valves are arranged to operate simultaneously so that in the open position of the inlet and outlet valves a continuous flow of dispersion is allowed from the uptake channel through the measurement chamber to the pump-mixer, and in the closed position of the inlet and outlet valves a sample of dispersion is retained in the measurement chamber for the measurement of O/A ratio and phase disengagement time.

In an embodiment of the mixer-settler the equipment comprises a control device configured to steer the position of the inlet and outlet valves.

In an embodiment of the mixer-settler the mixer-settler comprises an internal recirculation channel for circulating a portion of the aqueous phase from the settler or from an aqueous launder to the pump-mixer unit. A recirculation control valve is arranged to control the flow of the aqueous phase in the recirculation channel. The control device is configured to change the position of the recirculation control valve on the basis of the measured O/A ratio for controlling the internal O/A ratio of the mixer-settler to a predetermined level.

In an embodiment of the mixer-settler the measurement chamber comprises a horizontal bottom and a vertical cylindrical side wall, the height of the side wall defining the height H of the measurement chamber.

In an embodiment of the mixer-settler the equipment comprises a phase surface level measuring device for measuring the surface level of the organic phase in the measurement chamber.

In an embodiment of the mixer-settler the phase surface level measuring device is a guided radar level meter.

In an embodiment of the mixer-settler the equipment comprises a differential pressure measuring device for the measurement of the differential pressure of the liquid in the measurement chamber.

In an embodiment of the mixer-settler the differential pressure measuring device comprises an upper pressure detector located in the side wall below the horizontal symmetric axis of the measurement chamber so that the upper pressure detector remains below the surface level of the aqueous phase after the separation of the phases is complete. The differential pressure measuring device further comprises a lower pressure detector arranged in the side wall at a distance dH from the upper pressure detector and at a distance hₐ from the bottom of the measurement chamber.

In an embodiment of the mixer-settler the control device is arranged to calculate the O/A ratio as follows:

O/A ratio=(h/H−h)

wherein
h=the organic layer level
H=height of the measurement chamber

In an embodiment of the mixer-settler the control device is arranged to calculate the phase disengagement time PDT with the equation:

PDT=(1/dH)*(H−h−ha)*(Tb−Ta)+Ta

wherein
dH=the distance between the upper and lower pressure detectors,
h=the organic layer level
H=height of the measurement chamber
hₐ=distance of the lower pressure detector from the bottom of the measurement chamber
Ta=the instant of time when the pressure starts to increase
Tb=the instant of time when the pressure stabilizes.

In an embodiment of the mixer-settler the control device is configured to close the inlet and outlet valves at predetermined measuring intervals for a predetermined measuring period which is selected to be long enough to allow complete separation of the phases in the measurement chamber.

In an arrangement comprising at least two mixer-settlers, said mixer-settlers being arranged consecutively to form successive process stages. The control device is configured to change the position of the recirculation control valve on the basis of the O/A ratio and phase disengagement time measured at said succeeding stage in order the control the level of the organic launder in the preceding stage.

According to the invention, in the method, a continuous flow of dispersion is led from the uptake channel via an measurement chamber to the pump-mixer unit, and at predetermined time intervals said continuous flow is interrupted to retain a sample of dispersion in the measurement chamber for the measurement of the O/A ratio and phase disengagement time.

In an embodiment of the method the measurement sequence for the measurement of the O/A ratio and phase disengagement time follows the steps:
1) determining if the pump-mixer is running, if not go to step 1), if yes, go to step 2),
2) closing the inlet and outlet valves to retain the sample of dispersion in the measurement chamber,
3) waiting a predetermined period of time T1 to ensure complete phase separation in the measurement chamber,
4) measuring the organic layer level h,
5) calculating the O/A ratio:

O/A ratio=(h/H−h)

wherein
h=the organic layer level

H=height of the measurement chamber
6) calculating the phase disengagement time with the equation:

PDT=(1/dH)*(H−h−ha)*(Tb−Ta)+Ta

wherein
dH=the distance between the upper and lower pressure detectors,
h=the organic layer level
H=height of the measurement chamber
hₐ=distance of the lower pressure detector from the bottom of the measurement chamber
Ta=the instant of time when the pressure starts to increase
Tb=the instant of time when the pressure stabilizes,
7) opening the inlet and outlet valves,
8) waiting a predetermined period of time T2 which is the time interval between consecutive samplings,
9) going to step 1).

In an embodiment of the method the O/A ratio of the dispersion is controlled by controlling a recirculation flow of aqueous phase from the settler or from an aqueous launder to the pump-mixer on the basis of the measured O/A ratio and phase disengagement time.

In an embodiment of the method at least two mixer-settlers are arranged in succession to form successive process stages and the level of the organic launder of a preceding stage is controlled by controlling the recirculation flow on the basis of the measured O/A ratio and phase disengagement time in the succeeding stage.

In an embodiment of the method the recirculation valve is controlled by the steps of:
1) determining if the pump-mixer is running, if not to step 1), if yes, going to step 2),
2) closing the inlet and outlet valves,
3) waiting a predetermined period of time T1 to ensure complete phase separation in the measurement chamber,
4) measuring the organic layer level h,
5) calculating the O/A ratio:

O/A ratio=(h/H−h)

wherein
h=the organic layer level
H=height of the measurement chamber
6) calculating the phase disengagement time with the equation:

PDT=(1/dH)*(H−h−ha)*(Tb−Ta)+Ta

wherein
dH=the distance between the upper and lower pressure detectors,
h=the organic layer level
H=height of the measurement chamber
hₐ=distance of the lower pressure detector from the bottom of the measurement chamber
Ta=the instant of time when the pressure starts to increase
Tb=the instant of time when the pressure stabilizes,
   and storing in O/Aᵢ, wherein i is the order number of the measurement,
7) opening the inlet and outlet valves,
8) determining if |O/Aᵢ₋₁−O/Aᵢ|<0.05, if yes, then going to step 12), in not then going to step 9),
9) calculating the value of the control output for position of the recirculation valve:

% FFCᵢ₊₁=% FFCᵢ−(O/Aᵢ*(% FFCᵢ−% FFCᵢ₋₁))/(O/Aᵢ−O/Aᵢ₋₁)
10) making O/Aᵢ=O/Aᵢ₋₁
11) updating the recirculation valve position with % FFCᵢ₊₁
12) waiting a predetermined period of time T2 which is the time interval between consecutive samplings,
13) going to step 1),
   wherein O/Aᵢ=the i^{th} ratio measurement and
% FFCᵢ=the i^{th} value of the control output (recirculation valve position).

The advantage of the invention is that the sampling and measurement procedure can be automated. The human factor in taking the sample can be eliminated as the sample is always taken at the same location from the uptake channel. The measurement results are therefore more reliable. The measured values of O/A ratio and phase disengagement time can be automatically recorded in the control system of the plant. The measurements can be made more frequently. The O/A ratio can be automatically changed and maintained along the time. If the rotation speed of the pump-mixer is changed due some operational condition, the O/A ratio can be maintained automatically.

### LIST OF DRAWINGS

The accompanying drawing, which is included to provide a further understanding of the invention and constitutes a part of this specification, illustrates an embodiment of the invention and together with the description helps to explain the principles of the invention. FIGURE shows one embodiment of a mixer-settler according to the invention provided with the O/A ratio and phase disengagement time measuring equipment.

### DETAILED DESCRIPTION OF INVENTION

FIGURE is a schematic illustration of a mixer-settler which comprises a pump-mixer unit 1, a liquid-liquid extraction settler 2 and an equipment 3 configured to measure the volumetric O/A ratio and phase disengagement time PDT of organic O and aqueous A phases in a dispersion. The dispersion is prepared by the pump-mixer unit 1. The unit 1 comprises a dispersion over-flow pump DOP followed by two mixers. The dispersion is fed from the last mixer to the settler via an uptake channel 4.

The measurement equipment 3 comprises a measurement chamber 5 which is arranged to receive a sample of dispersion for the measurement of the O/A ratio and the phase disengagement time. The equipment 3 further comprises an inlet channel 6 having a first end 7 opening to the uptake channel 4 and a second end 8 opening to the measurement chamber 5, said inlet channel forming a channel for the inflow of the sample into the measurement chamber. An outlet channel 9 has a third end 10 which opens to the measurement chamber 5 and a fourth end 11 opening to the pump-mixer unit. The outlet channel 9 forms a channel for the outflow of the sample out from the measurement chamber 5. An inlet valve 12 which is a steered shut-off valve is arranged in the inlet channel 6. The inlet valve 12 has an open position to allow the flow in the inlet channel 6, and a closed position to stop the flow in the inlet channel 6. An outlet valve 13 which is a steered shut-off valve is arranged in the outlet channel 9. The outlet valve 13 has an open position to allow the flow in the outlet channel 9, and a closed position to stop the flow in the outlet channel 9. The equipment 3 comprises a control device 14 which is configured to steer the position of the inlet and outlet valves 12, 13.

The inlet and outlet valves 12, 13 are arranged to operate simultaneously so that in the open position of the inlet and outlet valves a continuous small recirculation flow of dispersion is allowed from the uptake channel 4 through the measurement chamber 5 to the pump-mixer 1, and in the closed position of the inlet and outlet valves 12, 13 a sample of dispersion is retained in the measurement chamber 5 so that the natural phase separation between organic and aqueous solutions happens and the measurement of O/A ratio and phase disengagement time can take place. In the FIGURE the inlet and outlet valves 12, 13 are in a closed position and the phase separation of organic O and aqueous phases A has happened. The aqueous phase A being heavier solution of the two solutions is the lower layer in the chamber 5 and the organic layer O being the lighter solution of the two solutions is the upper layer in the chamber 5.

The mixer-settler further comprises an internal recirculation channel 15 for circulating a portion of the aqueous phase from the settler 2 to the pump-mixer unit 1 (illustrated with an unbroken line). Additionally or optionally the internal recirculation channel 15 may circulate a portion of the aqueous phase from the aqueous launder 23 (illustrated with a broken line) located at the discharge end of the settler 2.

A recirculation control valve 16 is arranged to control the flow of the aqueous phase in the recirculation channel 15. The control device 14 is configured to change the position or the recirculation control valve 16 on the basis of the measured O/A ratio for controlling the internal O/A ratio of the mixer-settler to a pre-determined level.

The measurement chamber 5 comprises a horizontal bottom 17 and a vertical cylindrical side wall 18. The height of the side wall 18 defines the height H of the measurement chamber 5. The equipment 3 comprises a phase surface level measuring device 19 for measuring the surface level h of the organic phase O in the measurement chamber. The phase surface level measuring device 19 can be a guided radar level meter.

The equipment 3 further comprises a differential pressure measuring device 20 for the measurement of the differential pressure of the liquid in the measurement chamber 5. The differential pressure measuring device 20 comprises an upper pressure detector 21 located in the side wall 18 below the horizontal symmetric axis T-T of the measurement chamber 5 so that the upper pressure detector remains below the surface level of the aqueous phase after the separation of the phases is complete. A lower pressure detector 22 is arranged in the side wall at a distance dH from the upper pressure detector and at a distance hₐ from the bottom of the measurement chamber.

The control device 14 is arranged to calculate the O/A ratio as follows:

O/A ratio=(h/H−h)

wherein
h=the organic layer level
H=height of the measurement chamber 5

The control device 14 is arranged to calculate the phase disengagement time PDT with the equation:

PDT=(1/dH)*(H−h−ha)*(Tb−Ta)+Ta

wherein
dH=the distance between the upper and lower pressure detectors,
h=the organic layer level
H=height of the measurement chamber
hₐ=distance of the lower pressure detector from the bottom of the measurement chamber
Ta=the instant of time when the pressure starts to increase
Tb=the instant of time when the pressure stabilizes.

The control device 14 is configured to close the inlet and outlet valves 12, 13 at predetermined measuring intervals (could be e.g. 10 to 60 minutes) for a predetermined measuring period which is selected to be long enough to allow complete separation of the phases in the measurement chamber 5. The time required for complete phase separation in the chamber 5 is normally below 3 minutes).

The measurement sequence for the measurement of the O/A ratio and phase disengagement time follows the steps:
1) determining if the pump-mixer (1) is running, if not go to step 1), if yes, go to step 2),
2) closing the inlet and outlet valves (12, 13) to retain the sample of dispersion in the measurement chamber (5),
3) waiting a predetermined period of time T1 to ensure complete phase separation in the measurement chamber,
4) measuring the organic layer level h,
5) calculating the O/A ratio:

O/A ratio=(h/H−h)

wherein
h=the organic layer level
H=height of the measurement chamber
6) calculating the phase disengagement time with the equation:

PDT=(1/dH)*(H−h−ha)*(Tb−Ta)+Ta

wherein
dH=the distance between the upper and lower pressure detectors,
h=the organic layer level
H=height of the measurement chamber
hₐ=distance of the lower pressure detector from the bottom of the measurement chamber
Ta=the instant of time when the pressure starts to increase
Tb=the instant of time when the pressure stabilizes,
7) opening the inlet and outlet valves 12, 13,
8) waiting a predetermined period of time T2 which is the time interval between consecutive samplings,
9) going to step 1).

The O/A ratio of the dispersion is controlled by controlling a recirculation flow of aqueous phase from the settler 2 to the pump-mixer 1 on the basis of the measured O/A ratio and phase disengagement time.

When at least two mixer-settlers are arranged in succession to form successive process stages and the level of the organic launder of a preceding stage can be controlled by controlling the recirculation flow in the succeeding stage on the basis of the measured O/A ratio and phase disengagement time in the succeeding stage.

The recirculation valve 16 is controlled by the steps of:
1) determining if the pump-mixer 1 is running, if not to step 1), if yes, going to step 2),
2) closing the inlet and outlet valves 12, 13,
3) waiting a predetermined period of time T1 to ensure complete phase separation in the measurement chamber,
4) measuring the organic layer level h,
5) calculating the O/A ratio:

O/A ratio=(h/H−h)
wherein h=the organic layer level
H=height of the measurement chamber

6) calculating the phase disengagement time with the equation:

PDT=(1/dH)*(H−h−ha)*(Tb−Ta)+Ta

wherein
dH=the distance between the upper and lower pressure detectors,
h=the organic layer level
H=height of the measurement chamber
hₐ=distance of the lower pressure detector from the bottom of the measurement chamber
Ta=the instant of time when the pressure starts to increase
Tb=the instant of time when the pressure stabilizes,
and storing in O/Aᵢ, wherein i is the order number of the measurement,
7) opening the inlet and outlet valves 12, 13,
8) determining if |O/Aᵢ₋₁−O/Aᵢ|<0.05, if yes, then going to step 12), in not then going to step 9),
9) calculating the value of the control output for position of the recirculation valve (16):

% FFCᵢ₊₁=% FFCᵢ−(O/Aᵢ* (% FFCᵢ−% FFCᵢ₋₁))/(O/Aᵢ−O/Aᵢ₋₁)
10) making O/Aᵢ=O/Aᵢ₋₁
11) updating the recirculation valve position with % FFCᵢ₊₁
12) waiting a predetermined period of time T2 which is the time interval between consecutive samplings,
13) going to step 1),
   wherein O/Aᵢ=the i^{th} ratio measurement and
% FFCᵢ=the i^{th} value of the control output (recirculation valve position).

The control uses secant method for solving nonlinear equations, because a traditional sampled PID loop can oscillate. The convergence of the loop is guaranteed using Lyapunov theorem. As well, other numeric blind procedures can be used.

It is obvious to a person skilled in the art that with the advancement of technology, the basic idea of the invention may be implemented in various ways. The invention and its embodiments are thus not limited to the examples described above, instead they may vary within the scope of the claims.

1. A mixer-settler comprising a pump-mixer unit (1), a liquid-liquid extraction settler (2) and an equipment (3) configured to measure the volumetric O/A ratio and phase disengagement time (PDT) of organic (O) and aqueous (A) phases in a dispersion prepared by said pump-mixer unit (1) before feeding the dispersion to said liquid-liquid extraction settler (2) via an uptake channel (4), the equipment (3) comprising
a measurement chamber (5) arranged to receive a sample of dispersion for the measurement of the O/A ratio and the phase disengagement time, characterized in that the equipment (3) comprises
an inlet channel (6) having a first end (7) opening to the uptake channel (4) and a second end (8) opening to the measurement chamber (5), said inlet channel forming a channel for the inflow of the sample into the measurement chamber,
an outlet channel (9) having a third end (10) opening to the measurement chamber (5) and a fourth end (11) opening to the pump-mixer unit, said outlet channel forming a channel for the outflow of the sample out from the measurement chamber,
an inlet valve (12) which is a steered shut-off valve arranged in the inlet channel (6), said inlet valve having an open position to allow the flow in the inlet channel, and a closed position to stop the flow in the inlet channel, and
an outlet valve (13) which is a steered shut-off valve arranged in the outlet channel (9), said outlet valve having an open position to allow the flow in the outlet channel, and a closed position to stop the flow in the outlet channel,
said inlet and outlet valves (12, 13) being arranged to operate simultaneously so that in the open position of the inlet and outlet valves a continuous flow of dispersion is allowed from the uptake channel (4) through the measurement chamber (5) to the pump-mixer (1), and in the closed position of the inlet and outlet valves (12, 13) a sample of dispersion is retained in the measurement chamber (5) for the measurement of O/A ratio and phase disengagement time.

2. The mixer-settler according to claim 1, characterized in that the equipment (3) comprises a control device (14) configured to steer the position of the inlet and outlet valves (12, 13).

3. The mixer-settler according to claim 1, characterized in that the mixer-settler comprises
an internal recirculation channel (15) for circulating a portion of the aqueous phase from the settler (2) and/or from an aqueous launder (23) to the pump-mixer unit (1);
a recirculation control valve (16) arranged to control the flow of the aqueous phase in the recirculation channel (15);
and that the control device (14) is configured to change the position or the recirculation control valve (15) on the basis of the measured O/A ratio for controlling the internal O/A ratio of the mixer-settler to a pre-determined level.

4. The mixer-settler according to claim 1, characterized in that the measurement chamber (5) comprises a horizontal bottom (17) and a vertical cylindrical side wall (18), the height of the side wall defining the height H of the measurement chamber.

5. The mixer-settler according to claim 1, characterized in that the equipment comprises a phase surface level measuring device (19) for measuring the surface level (h) of the organic phase (O) in the measurement chamber.

6. The mixer-settler according to claim 1, characterized in that the phase surface level measuring device (19) is a guided radar level meter.

7. The mixer-settler according to claim 1, characterized in that the equipment comprises a differential pressure measuring device (20) for the measurement of the differential pressure of the liquid in the measurement chamber (5).

8. The mixer-settler according to claim 7, characterized in that that the differential pressure measuring device (20) comprises
an upper pressure detector (21) located in the side wall (18) below the horizontal symmetric axis (T-T) of the measurement chamber (5) so that the upper pressure detector remains below the surface level of the aqueous phase after the separation of the phases is complete, and
a lower pressure detector (22) arranged in the side wall at a distance dH from the upper pressure detector and at a distance hₐ from the bottom of the measurement chamber.

9. The mixer-settler according to claim 8, characterized in that the control device (14) is arranged to calculate the O/A ratio as follows:
O/A ratio=(h/H−h)
wherein
h=the organic layer level
H=height of the measurement chamber

10. The mixer-settler according to claim 8, characterized in that the control device (14) is arranged to calculate the phase disengagement time PDT with the equation:
PDT=(1/dH)*(H−h−ha)*(Tb−Ta)+Ta
wherein
dH=the distance between the upper and lower pressure detectors,
h=the organic layer level
H=height of the measurement chamber
hₐ=distance of the lower pressure detector from the bottom of the measurement chamber
Ta=the instant of time when the pressure starts to increase
Tb=the instant of time when the pressure stabilizes.

11. The mixer-settler according to claim 1, characterized in that the control device (14) is configured to close the inlet and outlet valves (12, 13) at predetermined measuring intervals for a predetermined measuring period which is selected to be long enough to allow complete separation of the phases in the measurement chamber (5).

12. An arrangement comprising at least two mixer-settlers, said mixer-settlers being arranged consecutively to form successive process stages wherein at least a succeeding stage comprises a mixer-settler according to claim 1, characterized in that the control device (14) is configured to change the position of the recirculation control valve (16) on the basis of the O/A ratio and phase disengagement time measured at said succeeding stage in order the control the level of the organic launder in the preceding stage.

13. A method for measuring and controlling the volumetric O/A ratio and phase disengagement time (PDT) of organic (O) and aqueous (A) phases in a dispersion prepared by a pump-mixer unit (1) before feeding the dispersion to liquid-liquid extraction settler (2) via an uptake channel (4), characterized in that a continuous flow of dispersion is led from the uptake channel (4) via an measurement chamber (5) to the pump-mixer unit (1), and at predetermined time intervals said continuous flow is interrupted to retain a sample of dispersion in the measurement chamber (5) for the measurement of the O/A ratio and phase disengagement time.

14. The method according to claim 13, characterized in that the measurement sequence for the measurement of the O/A ratio and phase disengagement time follows the steps:
1) determining if the pump-mixer (1) is running, if not go to step 1), if yes, go to step 2),
2) closing the inlet and outlet valves (12, 13) to retain the sample of dispersion in the measurement chamber (5),
3) waiting a predetermined period of time T1 to ensure complete phase separation in the measurement chamber,
4) measuring the organic layer level h,
5) calculating the O/A ratio:
O/A ratio=(h/H−h)
wherein
h=the organic layer level
H=height of the measurement chamber
6) calculating the phase disengagement time with the equation:
PDT=(1/dH)*(H−h−ha)*(Tb−Ta)+Ta
wherein
dH=the distance between the upper and lower pressure detectors,
h=the organic layer level
H=height of the measurement chamber
hₐ=distance of the lower pressure detector from the bottom of the measurement chamber
Ta=the instant of time when the pressure starts to increase
Tb=the instant of time when the pressure stabilizes,
7) opening the inlet and outlet valves (12, 13),
8) waiting a predetermined period of time T2 which is the time interval between consecutive samplings,
9) going to step 1).

15. The method according to claim 14, characterized in that the O/A ratio of the dispersion is controlled by controlling a recirculation flow of aqueous phase from the settler (2) and/or from an aqueous launder (23) to the pump-mixer (1) on the basis of the measured O/A ratio and phase disengagement time.

16. The method according to claim 1, characterized in that at least two mixer-settlers are arranged in succession to form successive process stages and the level of the organic launder of a preceding stage is controlled by controlling the recirculation flow on the basis of the measured O/A ratio and phase disengagement time in the succeeding stage.

17. The method according to claim 14, characterized in that the recirculation valve (16) is controlled by the steps of:
1) determining if the pump-mixer (1) is running, if not to step 1), if yes, going to step 2),
2) closing the inlet and outlet valves (12, 13),
3) waiting a predetermined period of time T1 to ensure complete phase separation in the measurement chamber,
4) measuring the organic layer level h,
5) calculating the O/A ratio:
O/A ratio=(h/H−h)
wherein
h=the organic layer level
H=height of the measurement chamber
6) calculating the phase disengagement time with the equation:
PDT=(1/dH)*(H−h−ha)*(Tb−Ta)+Ta
wherein
dH=the distance between the upper and lower pressure detectors,
h=the organic layer level
H=height of the measurement chamber
hₐ=distance of the lower pressure detector from the bottom of the measurement chamber
Ta=the instant of time when the pressure starts to increase
Tb=the instant of time when the pressure stabilizes,
and storing in O/Aᵢ, wherein i is the order number of the measurement,
7) opening the inlet and outlet valves (12, 13),
8) determining if |O/Aᵢ₋₁−O/Aᵢ|<0.05, if yes, then going to step 12), in not then going to step 9),
9) calculating the value of the control output for position of the recirculation valve (16):
% FFCᵢ₊₁=% FFCᵢ−(O/Aᵢ*(% FFCᵢ−% FFCᵢ₋₁))/(O/Aᵢ−O/Aᵢ₋₁)
10) making O/Aᵢ=O/Aᵢ₋₁
11) updating the recirculation valve position with % FFCᵢ₊₁
12) waiting a predetermined period of time T2 which is the time interval between consecutive samplings,
13) going to step 1),
wherein
O/Aᵢ=the i^{th} ratio measurement and
% FFCᵢ=the i^{th} value of the control output (recirculation valve position).
